(19) United States
(12) Patent Application Publication
(10) Pub. No.: US 2019/0230405 A1
(43) Pub. Date: Jul. 25, 2019

(54) SUPPLEMENTAL VIDEO CONTENT DELIVERY

(71) Applicant: Comcast Cable Communications, LLC, Philadelphia, PA (US)

(72) Inventor: Vijey Jenkal, Philadelphia, PA (US)

(21) Appl. No.: 15/876,617

(22) Filed: Jan. 22, 2018

(51) Int. Cl. H04N 21/431; H04N 21/442; H04N 21/436

(52) U.S. Cl. CPC H04N 21/4316; H04N 21/43615; H04N 21/44231; H04N 21/44218

(57) ABSTRACT

Systems, methods, and apparatuses are described for supplemental video content delivery. A first device may display content. The content may be modified, based on activity on a second device, to comprise supplemental content. The modified content may be displayed by the first device.

### BACKGROUND

A user may interact with a user device associated with the user, while also in proximity to a display device, such as a television. The user may direct attention to content playing on the television instead of the user device. Alternatively, the user may direct attention to the user device, while paying less attention to the content on the television. Improvements in content delivery and presentation via multiple devices viewable to a user are needed. These and other shortcomings are addressed in the disclosure.

### SUMMARY

Systems, methods, and apparatuses are described for supplemental video content delivery. Supplemental video content may be displayed on one device based on associated activity on another device. For example, a user may view content, such as a television program, on a primary display device, while also interacting with a user device, such as a mobile device. Based on the activity on the user device, the content may be modified to include supplemental content, such as an advertisement. The modified content may be displayed via the primary display device.

### BRIEF DESCRIPTION OF DRAWINGS

The accompanying drawings, which are incorporated in and constitute a part of this specification, show embodiments and together with the description, serve to explain the principles of the methods and systems:

FIG. 1A shows a schematic diagram of a system;

FIG. 1B shows a schematic diagram of a system;

FIG. 2 shows a flow diagram of operational data structures;

FIG. 3 shows a method;

FIG. 4 shows a method;

FIG. 5 shows a method;

FIG. 6 shows a schematic diagram of a segmentation of a content asset;

FIG. 7 shows a schematic diagram of a segmentation of a content asset; and

FIG. 8 shows a schematic diagram of a computing system.

### DETAILED DESCRIPTION

Systems and methods are described for delivery of supplemental content. The supplemental content (e.g., a supplemental content asset) may be selected and/or delivered to a primary display device based on contemporaneous activity occurring on a secondary device. The supplemental content asset may comprise an advertisement, video, audio, and/or the like. The primary display device may comprise a television. The secondary device may comprise a user device, such as a smart phone, a mobile device, laptop computer, or desktop computer. A mobile device may comprise a smart phone or tablet computer. The supplemental content asset may be inserted into or otherwise used to modify a content asset (e.g., a television program) already being displayed on the primary display device.

As a user performs activities on the secondary device, attention may be diverted from the primary display device. A supplemental content asset may be presented at a later time when the user is paying less attention to the secondary device. A supplemental content asset may be presented on the primary display device that has content related to the activity occurring on the secondary device.

An indication of the activity on the secondary device may be monitored and transmitted to a computing device that may coordinate delivery of the content asset. The indication of activity on the secondary device may reflect various characteristics of the operations (e.g., the user's operations) of the secondary device and/or applications executing thereon.

The indication of the activity may comprise an indication of the subject matter of the activity. The indication of the subject matter of a web browsing activity may reflect the topic of that web page. The indication of the activity may additionally or alternatively comprise an indication of user interaction with the secondary device. The indication of user interaction may reflect performance of a number of inputs (e.g., touch inputs or swipe gestures to a touch-sensitive display) within a period of time. The indication of activity may comprise a factor representing attention (e.g., from a user) to the secondary device. This factor may be based on the type of application relating to the activity. A word processing application may indicate greater attention to the secondary device than a social media application.

The indication of activity on the secondary device may be used to determine a supplemental content asset to display on the primary display device and/or the timing at which the supplemental content asset is displayed on the primary display device. The content of the supplemental content asset may be selected to match that of the subject matter of the activity on the secondary device. The supplemental content asset may be displayed on the primary display device during or soon after the activity on the secondary device occurs, such as if the indication of activity reflects a low degree of attention to the secondary device. However, if the indication of activity reflects a high degree of attention to the secondary device, the display of the supplemental content asset may be delayed to a later time.

The supplemental content asset may be displayed on the primary display device, such as based on the determining the supplemental content asset. The display of the supplemental content asset may interrupt a content asset currently being displayed.

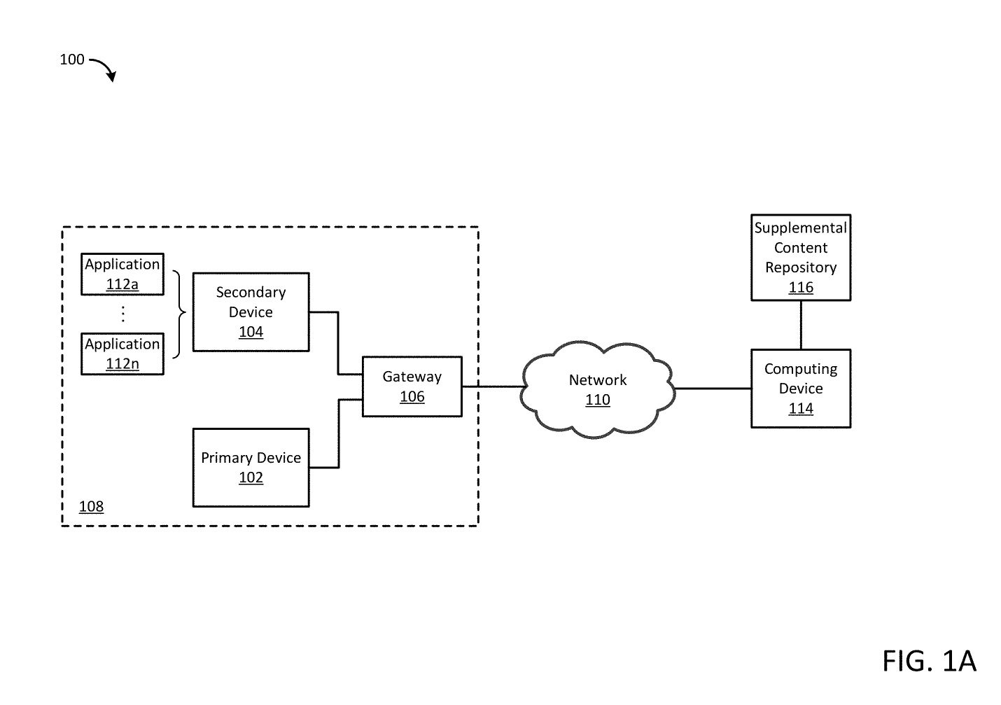

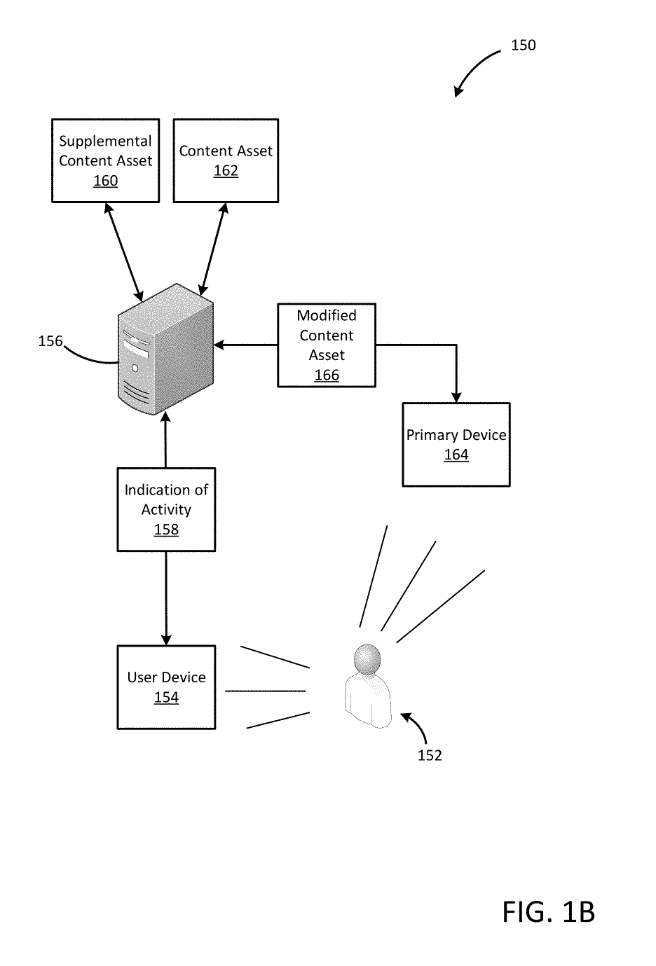

FIG. 1A shows a system 100 in which the various operations and techniques relating to supplemental video content delivery may be implemented. The system 100 may comprise a primary device 102 and a secondary device 104. The primary device 102 and the secondary device 104 may be located at a common premises 108. The secondary device 104 may comprise one or more applications 112a-112n executing thereon. The primary device 102 may access or receive a content asset from a computing device 114 via a network 110 and/or a gateway 106. The primary device 102 may display or cause to display the content asset. Based on contemporaneous activity on the secondary device 104, the content asset may be modified with supplemental content from a supplemental content repository 116.

The primary device 102 may comprise a display device configured to display and/or cause to display a content asset. The primary device 102 may comprise a stationary device. The primary device 102 may comprise a television set with an LCD (liquid crystal display), an LED (light emitting diode) display, a plasma display or the like. The primary device 102 may comprise a video projection system. The primary device 102 may be configured to receive and display a content asset transmitted over a co-axial cable network. The primary device 102 may be configured to connect to a digital network (e.g., the Internet) and receive a digital video stream or other digital embodiment of the content asset, such as may be the case with a “smart television.”

The reception and/or display of a content asset by the primary device 102 may be facilitated by one or more complementary devices. A complementary device may receive the cable television signal or digital video stream and process (e.g., decrypt and/or decode) the cable television signal or digital video stream. The cable television signal or the digital media stream may comprise, at least in part, the content asset. The complimentary device may transmit the content asset to the primary device 102 as a video signal. A complementary device may comprise a digital media player, an Internet-enabled DVD (digital video disc) or Blu-ray player, a video game console, or a set-top cable box.

The content asset displayed by the primary device 102 may comprise a television program, a sports event, a movie, a news program, or other form of video presentation. The content asset may be transmitted to the primary device 102 as a video stream (e.g., a digital video stream) which may be locally buffered and displayed on the primary device 102 as it is received. The content asset may be transmitted to the primary device 102 as a unitary asset and stored locally in association with the primary device 102 or complementary device before being displayed via the primary device 102. A DVR (digital video recorder) may record a content asset that may later be displayed by the associated primary device 102.

The content asset may be modified to comprise a supplemental content asset. A determination of the supplemental content asset with which the content asset may be modified may be based on activity contemporaneously occurring on the secondary device 104. As used herein, the supplemental content asset may refer to any content that is not originally part of the content asset. The supplemental content asset may comprise an advertisement, such as an advertisement for a particular make of car, food product, retail store, video game, and the like. The supplemental content asset may comprise a public service announcement or news information. The supplemental content asset may comprise an informational message relating to the user's cable television service, such as a reminder of when a bill is due.

The secondary device 104 may comprise a computing device on which a user may interact with one or more applications 112a-112n. The secondary device 104 may comprise a user device, such as a mobile device, a laptop computer, or a desktop computer. A mobile device may comprise a smart phone, tablet computer, or portable gaming device. The one or more applications 112a-112n that may execute on the secondary device 104 may comprise any of a variety of types of applications including, but not limited to, a web browser, an email client, a video game (e.g., Angry Birds, Words with Friends, or Clash of Clans), a word processing application (e.g., Microsoft Word), a shopping application (e.g., Amazon shopping application, Apple's iTunes store, or Apple's App Store), and a social media application (e.g., Facebook, Twitter, Instagram, or Snapchat). Each of the applications 112a-112n may comprise or be associated with an application identifier, an application genre or type identifier, a subject matter identifier, and/or an identifier of any other application characteristic.

The use of and/or interaction with the one or more applications 112a-112n may be ascertained through one or more techniques. The one or more applications 112a-112n on the secondary device 104 may comprise an application that monitors, records, and/or transmits the activity (e.g., activity of the user) with that application. This application may be associated with and/or provided by an entity, such as a cable television provider, that transmits the content asset(s) to the primary device 102. Many cable television providers make available an iOS or Android application for use on a respective type of smart phone or tablet. The application may enable a subscriber to access his or her account details, perform remote control operations with a corresponding primary device 102, and/or stream on-demand video content to the device. An application may additionally or alternatively monitor other applications running on the secondary device 104, as well as interactions from the user with the other applications. The number and/or relative timing of inputs (e.g., a frequency of inputs) to the other application, such as touch screen inputs, may be monitored. Many frequent inputs to an application may be indicative of a high degree of attention to that application. Conversely, few or infrequent inputs to an application may be indicative of a low degree of attention to that application.

The premises 108 may refer generally to a location at which the primary device 102 and the secondary device 104 may be located. The premises 108 may comprise a residence (e.g., a house or an apartment), a business location (e.g., an office space), or a public area (e.g., a sports bar). The primary device 102 and the secondary device 104 may be located at the premises 108 such that a user may view or perceive both the primary device 102 and the secondary device 104 at the same time. The primary device 102 may be located in a residence's living room while a user operates the secondary device 104 in the living room.

The gateway 106 may comprise a computing device that facilitates communication of the primary device 102 and/or the secondary device 104 with the network 110 and other upstream components. The gateway 106 may comprise a network device, such as a cable modem, a DSL (digital subscriber line) modem, a network bridge, a network switch, or a router. The gateway 106 may comprise an access point to a co-axial and/or optical fiber cable network, such as an outdoor cable box. The gateway 106 may comprise a satellite receiver for communicating with a satellite television and/or Internet access network. The gateway 106 may operate in wired and/or wireless configurations.

The gateway 106 may be located in association with the premises 108. The gateway 106 may be located within, attached to, or outside of the premises 108. The system 100 may comprise multiple gateways 106. One gateway 106 may facilitate communication of a content asset. The gateway 106 may communicate with a cable television network. The gateway 106 may facilitate communication relating to the activity associated with the secondary device 104. The gateway 106 may communicate with a network providing Internet access.

The gateway 106 may define a point of commonality between the primary device 102 and the secondary device 104. Communication to and/or from the primary device 102 and the secondary device 104 through a single gateway 106 may indicate that the primary device 102 and the secondary device 104 may be located at the same premises 108 and/or that the primary device 102 and the secondary device 104 are within a same area of perception with respect to a user. In the event that multiple gateways 106 are used, a determination that the multiple gateways are located at or otherwise associated with the same premises 108 may likewise indicate that the primary device 102 and the secondary device 104 may be located at the same premises 108 and/or that the primary device 102 and the secondary device 104 are within a same area of perception with respect to a user.

The gateway 106 may determine an activity and/or interaction occurring with respect to the secondary device 104. The gateway 106 may determine the activity and/or interaction according to data passing through the gateway 106. The gateway 106 may store or otherwise have access to a table of sources (e.g., IP addresses and/or port numbers) each corresponding to particular applications and/or activities relating to the secondary device 104. An application executing on the secondary device 104 may send data to and/or receive data from an IP address, via a port number, that is associated with that application. A video streaming application executing on the secondary device 104 may send data to (e.g., playback commands) and/or receive data from (e.g., digital video segments) a video streaming server with a certain IP address and/or over a certain port number. The gateway 106 may identify the server's IP address based on the aforementioned application data passing through the gateway 106. The server's IP address and or port number of the communication may be cross-referenced in the table to determine the corresponding application. The corresponding application may be the video streaming application. Likewise, a game application may generate bi-directional data traffic through the gateway 106 with a game server. The IP address of the game server and/or the port number of the communication may be determined from the data traffic and used in a similar fashion to identify that particular game application. Based on the data associated with the application passing through the gateway 106, it may be determined that a user is interacting with that application on the secondary device 104.

The network 110 may be configured as a local area network (LAN), a wide area network (WAN), the Internet, and the like. Further, the network 110 may comprise a wireless and/or a wired network. The network 110 may comprise a cellular network, such as a 3G (third generation) or LTE (Long Term Evolution) cellular network. The network 110 may comprise a satellite network or a Wi-Fi network. The network 110 may comprise an Ethernet network, a coaxial cable network, or a fiber optic network.

The computing device 114 may be embodied as one or more interconnected computing devices, such as servers and/or networking devices. The computing device 114 may transmit the content asset for display by the primary device 102. As such, the computing device 114 may be associated with a content source (not shown), such as a cable television provider or a video-on-demand provider. The computing device 114 may receive the content asset from the content source.

The computing device 114 may receive an indication of an activity on the secondary device 104. Based on the indication of activity on the secondary device 104, the computing device 114 may determine an appropriate supplemental content asset with which to modify the content asset being transmitted to the primary device 102. The computing device 114 may request for and receive the determined supplemental content asset from the supplemental content repository. The computing device 114 may effectuate the modification of the content asset with the supplemental content asset and transmit the modified content asset to the primary device 102.

FIG. 1B shows a system 150 in which various operations and techniques relating to supplemental video content delivery may be implemented. The system 150 may comprise a mobile device 154 (e.g., the secondary device 104 of FIG. 1A) and a primary device 164 (e.g., the primary device 102 of FIG. 1A). A user 152 may interact with the mobile device 154 and/or applications executing thereon. The user 152 and/or the mobile device 154 may be within a shared space with the primary device 164. The user 152 may be in a field of perception (e.g., visual or audio perception) with both the mobile device 154 and the primary device 164.

A content asset 162 may be transmitted to a computing device 156 (e.g., the computing device 114 of FIG. 1A). The content asset 162 may comprise a television program, a movie, a sporting event presentation, or the like. The content asset 162 may be transmitted as a digital streaming media. The computing device 156 may be associated with a content source, such as a cable provider or a streaming media provider. The computing device 156 may receive the content asset 162 and transmit (via any number of intermediary devices, if necessary) the content asset 162 to the primary device 164. The content asset 162 may be received in discrete portions (e.g., segments) by the computing device 156 and transmitted to the primary device 164 also in discrete portions, such as may be the case with a streaming media implementation. The discrete portions of the content asset 162 may facilitate modification of the content asset 162, such as insertion of a supplemental content asset 160 within the discrete portions of the content asset 162.

The user 152 may interact with the mobile device 154 and/or applications thereon. The user 152 may play a game, browse a webpage, or use a social media application. Such interactions may be captured and transmitted, as the indication of activity 158, to the computing device 156. The computing device 156 may process the indication of activity 158 and modify the content asset 162 with the supplemental content asset 160 based on the indication of activity 158. The modified content asset 166 may be transmitted to the primary device 164 and displayed thereon. The displayed modified content asset 166 may provide the user 152 with supplemental content contextually related to the user's 152 activity on the mobile device 154. The supplemental content asset 160 may relate to the activity on the mobile device 154 by subject matter, timing, and/or priority. The process and criteria for modifying the content asset 162 with the supplemental content asset 160 will be discussed in greater detail below.

Although this disclosure is discussed primarily within the context of video content and related components, the methods, systems, and apparatuses described herein are equally applicable to other forms of media content, such as audio content. A primary device may comprise a stereo receiver, a digital media player, or other device configured to deliver audio content. An audio content asset may comprise a music program, such as a song (or playlist thereof), a podcast, or a digital radio broadcast. A supplemental content asset may comprise an audio advertisement, such as a radio advertisement like that played in terrestrial radio broadcasts. A supplemental content asset may comprise an audio information message, a public service announcement, or an emergency message.

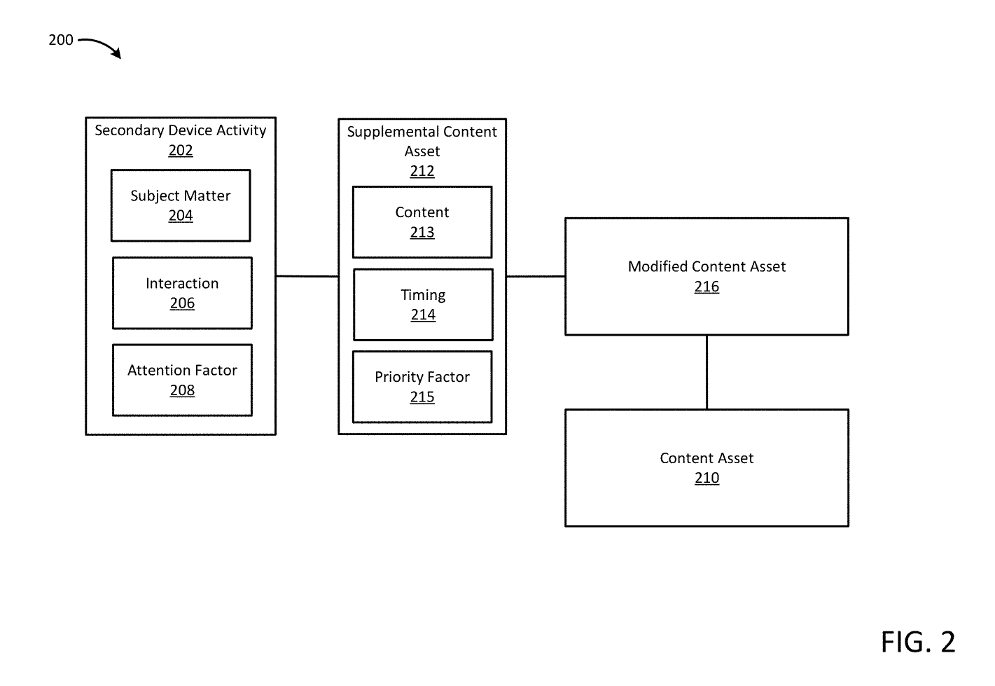

FIG. 2 shows a flow diagram 200. A supplemental content asset 212 is determined based, at least in part, on secondary device activity 202. The supplemental content asset 212 may be determined with respect to a content 213 of the supplemental content asset, a timing 214 of the supplemental content asset 212, and/or a priority factor 215 of the supplemental content asset. The secondary device activity 202 may comprise an indication of subject matter 204, an indication of interaction 206, and/or an attention factor 208. The supplemental content asset 212 may be used to modify a content asset 210 to generate the modified content asset 216.

The secondary device activity 202 may generally reflect the activity and/or interaction taking place on a secondary device (e.g., the secondary device 104 of FIG. 1A). The secondary device activity 202 may indicate that attention is directed to the secondary device and/or an application executing thereon. The secondary device activity 202 may comprise the indication of subject matter 204 relating to activity and/or interaction on the secondary device, the indication of interaction 206 relating to activity and/or interaction on the secondary device, and/or the attention factor 208 relating to activity and/or interaction on the secondary device.

The secondary device activity 202 and various components thereof may be determined by the secondary device. An application executing on the secondary device may be configured to monitor, store, and/or transmit the activity occurring on the secondary device, such as an identification of other applications executing on the secondary device. An application may additionally or alternatively monitor, store, and/or transmit a user's interaction with the secondary device and/or the user's interaction with a specific application.

Additionally or alternatively, the secondary device activity 202 and various components thereof may be determined by a gateway (e.g., the gateway 106). The gateway may monitor the data traffic between the secondary device and upstream components, such as a server associated with an application executing on the secondary device. The gateway may identify an IP address of the component with which the secondary device communicates. Based on that IP address, the gateway may identity the particular application associated with that IP address. Since the application is generating the data traffic through the gateway, it may be determined that the application is actively being used on the secondary device.

The indication of subject matter 204 may reflect the subject matter of the activity that occurs on the secondary device and/or the interaction that occurs with respect to the secondary device. The indication of subject matter 204 may reflect the subject matter of an application executing on the secondary device, such as an application being actively viewed and/or used by a user. The subject matter may indicate the type of application, such as an indication that the application is a word processing application, a game application (including a genre thereof), a web browsing application, or a social media application. The indication of subject matter 204 may reflect that the subject matter of the application is the teams and/or individual participants of a sports program, content of a webpage, and/or the content in a social media application, and/or content of an advertisement (e.g., one displayed in a webpage or a social media application).

The indication of interaction 206 may reflect a user's interaction with the secondary device and/or a particular application executing on the secondary device. The indication of interaction 206 may reflect user inputs, such as touch-screen inputs (e.g., touch points and/or swipes), voice inputs, and/or motion inputs (e.g., gyroscopic inputs and/or video detection of user movement). The indication of interaction 206 may comprise a time indicator. The time indicator may be a specific point of time or a time period during which a user interacts with the secondary device and/or an application. The indication of interaction 206 may comprise a frequency of interactions. The frequency of interaction may be the number of inputs within a time period. The period of time may be predetermined. The indication of interaction 206 may be with respect to particular content of an application. The indication of interaction 206 may comprise an input to a link. The link may be an advertising link. The indication of interaction 206 may comprise the object of that link. If a user selects an advertising link for a particular brand and/or type of vehicle, the indication of interaction 206 may comprise that brand and/or type of vehicle.

The attention factor 208 may reflect a degree of attention of a user to the secondary device and/or an application executing thereof. The attention factor 208 may reflect that a user is entering or has entered one or more inputs to the secondary device and/or an application. The attention factor 208 may be represented as a class of attention (e.g., high, medium, and low) or a numerical representation (e.g., a value between 1 and 100).

The attention factor 208 may be based on a type of inputs and/or a frequency of inputs. A high frequency of inputs during a period of time may indicate that the user is paying attention to the secondary device and/or an application. The attention factor 208 may be based on the frequency of inputs satisfying (e.g., exceeding or being less than) a threshold. The threshold may be predetermined. The attention factor 208 may be based on an internal mode or state of an application. The attention factor 208 may be based on a state of a video playback application (e.g., playing or paused). The attention factor 208 may be based on a state of a gaming application. The gaming application may be organized as active states (e.g., a gameplay round or level) and inactive or waiting states (e.g., in a “lobby screen” or between rounds or levels). The attention factor 208 may be determined based on a classification of an application according to a degree of attention associated with that application.

The supplemental content asset 212 may be determined based on the secondary device activity 202 and/or one or more components thereof. The supplemental content asset 212 may comprise an advertisement or an informational message, as discussed above. The content 213 of the supplemental content asset 212, the timing 214 at which the supplemental content asset 212 is displayed, and/or the priority factor 215 may be determined based on the secondary device activity 202.

With respect to the content 213 of the supplemental content asset 212, the content 213 may refer to the subject of the supplemental content asset 212. The content 213 of the supplemental content asset 212 may be determined based on the secondary device activity 202 and/or one or more components thereof. The content 213 may be determined based on the indication of subject matter 204 of the secondary device activity 202. The content 213 may be determined to correspond with the indication of the subject matter 204. If a user is playing a game in a particular genre of game applications, the content 213 may comprise an advertisement for a game in the same genre. If a user is viewing a webpage relating to a particular sports team, the content 213 may relate to that sport team. The content 213 may comprise an indication that the next upcoming game for that sports team is occurring the following Sunday at 2:00 PM. If a user is viewing a particular movie of a movie franchise within a video playback application, the content 213 may comprise an indication that another movie within that movie franchise is also available for viewing.

The timing 214 of the supplemental content asset 212 may comprise a designation of a time at which the supplemental content asset 212 is to be displayed on the primary device and/or a time in the content asset 210 to insert the supplemental content asset 212. The time may comprise a singular point in time or a time range. The timing 214 may indicate a first period of time and a second period of time. The supplemental content asset 212 may be designated as playing during one or both of the first and second periods of time. The first and second periods of time may be contiguous with one another. The first and/or second periods of time may coincide, at least in part, with activity (or lack thereof) occurring with respect to the secondary device. The timing 214 may be determined based on the secondary device activity 202 and/or one or more components thereof.

The timing 214 may be determined based on the subject matter 204 of the secondary device activity 202. The time at which a supplemental content asset 212 having particular content related to or corresponding to the subject matter 204 of the activity on the secondary device may be determined to coincide with that activity on the secondary device. The subject matter 204 of the secondary device activity 202 may indicate that the user is browsing a web page about a particular content asset. A supplemental content asset 212 relating to the content asset (e.g., an advertisement for an upcoming broadcast) may be designated to be displayed while the user is browsing that web page. That is, the web browsing activity on the secondary device may occur at a first time period and the supplemental content asset 212 may be designated to be displayed during the same first time period. The user may browse the web page about the content asset during a first time period. The supplemental content asset 212 relating to the content asset may be designated to be displayed during a second time period after the first time period.

The timing 214 may be determined based on the indication of interaction 206. The designated time to display the supplemental content asset 212 may be delayed to a later second period of time. The designated time to display the supplemental content asset 212 may be delayed to a later second period of time based on the indication of interaction 206 representing a high frequency of inputs (e.g., exceeding a threshold, which may be predetermined.) to the secondary device and/or an application thereon during a first period of time. The supplemental content asset 212 may be more likely to be viewed and heeded by the user during the second period of time when, presumably, the user is less occupied with the secondary device. Based on the indication of interaction 206 representing a low frequency of inputs (e.g., less than a threshold, which may be predetermined) during a period of time, the supplemental content asset 212 may be designated to display during that period of time. The user may be more likely to pay attention to the displayed supplemental content asset 212 during this period of time since the user is not actively (or at least to a lesser degree) interacting with the secondary device or application.

The timing 214 may be determined based on the attention factor 208 relating to the secondary device and/or an application. The display of the supplemental content asset 212 may be timed according to when the user is least likely to direct his or her attention to the secondary device and, thus, be more likely to direct his or her attention to the supplemental content asset 212 displayed on the primary device, and vice versa. The attention factor 208 may be based on an identification of an application with which the user is currently interacting and a corresponding degree of attention associated with that application. The supplemental content asset 212 may be displayed during a time period corresponding to an interaction with a low attention application. The supplemental content asset 212 may be displayed during a time period other than when a high attention application is being used. Based on the attention factor 208 satisfying a threshold with respect to a period of time, the supplemental content asset 212 may be displayed during this period of time or displayed during another period of time, as the case may be. The threshold with respect to the period of time may be predetermined.

The supplemental content asset 212 may comprise a priority factor 215. The priority factor 215 may represent a relative priority according to which the supplemental content asset 212 is to be displayed. Based on two supplemental content assets 212 being otherwise equal with respect to the content 213 and the timing 214 (e.g., the same potential display time period), the supplemental content asset 212 with a higher priority may be designated to be displayed on the primary device during this time period. The priority factor 215 may comprise a classification (e.g., high priority or low priority) or a numerical representation.

The priority factor 215 may be determined based on the indication of subject matter 204 of the secondary device activity 202. An advertiser may have paid a premium to a content provider for their supplemental content asset 212 to receive display priority. The priority may apply when a secondary device user causes to execute and/or interacts with an application associated with a particular subject matter. In other words, the priority factor 215 for the supplemental content asset 212 may be with respect to a particular subject matter. The supplemental content asset 212 may have a first priority factor 215 applicable to one subject matter 204 and a second priority factor 215 applicable to one or more other subject matters 204.

The priority factor 215 may be determined based on the indication of interaction 206. The priority factor 215 may be associated with a particular characteristic of interaction in the indication of interaction 206. The supplemental content asset 212 may have a first priority factor 215 associated with one characteristic of interaction (e.g., a high frequency of interaction) and a second priority factor 215 associated with another characteristic of interaction (e.g., a low frequency of interaction). Based on the first characteristic of interaction occurring, the first priority factor 215 may be applicable to the time period of the interaction. Based on the second characteristic of interaction occurring, the second priority factor 215 may be applicable to the time period of the interaction. A supplemental content asset provider may have arranged for a reduced fee for display of their supplemental content assets during periods of frequent interactions with the secondary device. A supplemental content asset provider may have arranged to pay a premium fee for display of their supplemental content assets during periods of infrequent interactions with the secondary device.

The priority factor 215 may be determined based on the attention factor 208 of the secondary device activity 202. Based on the attention factor 208 indicating a high degree of user attention to the secondary device, the priority factor 215 may indicate a low priority factor 215 for a supplemental content asset 212. Based on the attention factor 208 indicating a low degree of user attention to the secondary device, the priority factor 215 may indicate a high priority factor 215 for a supplemental content asset 212. The priority factor 215 may be inversely proportional to the attention factor 208.

The content asset 210 may be modified based on the supplemental content asset 212 (and/or components thereof) to form the modified content asset 216. The content asset 210 may be modified while the content asset 210 is being contemporaneously displayed. That is, a first portion of the content asset 210 may be displayed on the primary device. A second, later portion of the content asset 210 may be modified with the supplemental content asset 212 and displayed on the primary device. The second (modified) portion of the content asset 210 may be displayed on the primary device after the first (unmodified) portion of the content asset 210. A third later portion of the content asset 210, unmodified by the supplemental content asset 212, may be displayed on the primary device after the second (modified) portion of the content asset 210. The beginning of a content asset may be displayed on a television. An advertisement may be shown midway through the content asset. After the advertisement is shown, the content asset may resume.

The content asset 210 may be modified to comprise a supplemental content asset 212 having the determined content 213. The content asset 210 may be modified to insert the supplemental content asset 212 in the content asset 210 at a determined time or period of time with respect to the content asset 210. This time or period of time within the content asset 210 may be determined according to the timing 214 of the supplemental content asset 212.

The content asset 210 may have designated times or time periods therein for insertion of one or more supplemental content assets. The designated time or time periods in the content asset 210 may comprise one or more designated “commercial breaks” in the content asset. The designated time or time periods in the content asset 210 may occur at regular intervals in the content asset. The regular intervals in the content asset may be every 10 minutes, 20 minutes, or 30 minutes. A selection may occur from among the various designated times or time periods within the content asset 210 at which to insert the supplemental content asset. The selection of the designated time or time period within the content asset 210 may be based on a comparison to the time information indicated in the timing 214 of the supplemental content asset 212. The comparison may comprise determining a best match to the time information indicated in the timing 214 of the supplemental content asset 212.

The supplemental content asset 212 may be inserted at any time point within the content asset 210, without regard to any designated time or time period for such insertion. The supplemental content asset 212 may be inserted within the content asset 210 such that the supplemental content asset 212 is displayed on the primary device based on a determination of certain activity on the secondary device. Based on a low-attention activity being detected on the secondary device, a high-priority supplemental content asset may be inserted into the content asset for display coinciding with the low-attention activity. The high-priority supplemental content may be more likely to be viewed by the user.

The content asset 210 may be modified with the supplemental content asset 212 based on the priority factor 215 of the supplemental content asset 212. Based on a first potential supplemental content asset 212 comprising a high priority factor 215 and a second potential supplemental content asset 212 comprising a low priority factor 215 being considered for use in modifying the content asset 210, the first supplemental content asset 212 with the high priority factor 215 may be selected for use in modification of the content asset 210.

The modified content asset 216 may be displayed or caused to be displayed on the primary device. The modified content asset 216 may be transmitted as a video signal from a set-top cable box to a television display. The set-top cable box may have performed the modification to the content asset or the set-top cable box may have received the modified content asset 216 from an upstream component, such as a system of a content provider.

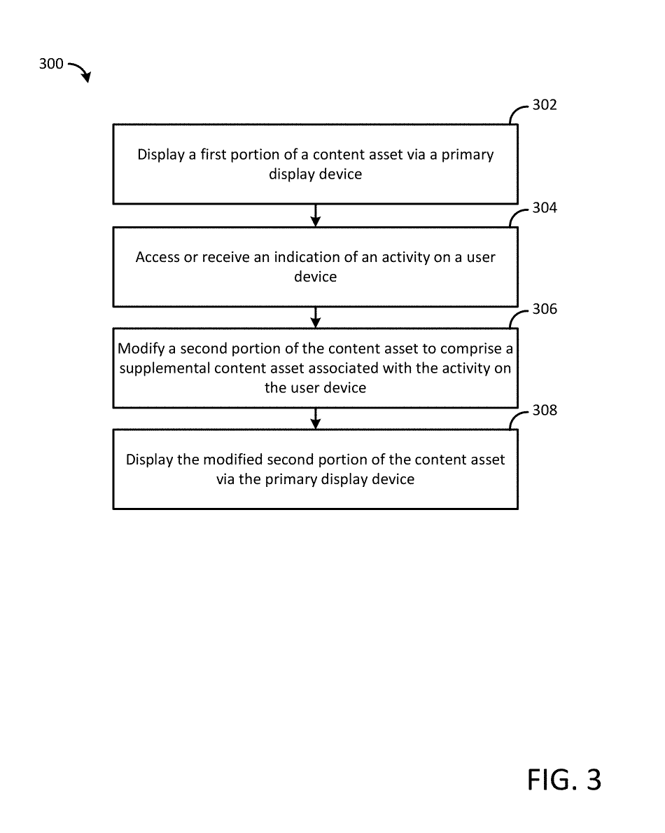

FIG. 3 shows a method 300 to display a supplemental content asset based on activity on a secondary device. At step 302, at least a first portion of a content asset (e.g., the content asset 210 of FIG. 2) may be displayed or caused to be displayed via a primary display device (e.g., the primary device 102 of FIG. 1A). Displaying may comprise outputting and causing to display or be displayed may comprise causing output. A content asset may comprise a television program, a movie, a sports presentation, a music video, or the like. The primary display device may comprise a device configured to display video content, such as a television display. The primary display device may comprise a complementary device configured to facilitate display. The primary display device may comprise a digital media player, a set-top cable box, or a game console. The primary display device may be configured to access or receive video content from an upstream computing device. The content asset may be transmitted to the primary display device via a co-axial cable network or a digital network (e.g., the Internet).

At step 304, an indication of an activity on a user device (e.g., the secondary device 104 of FIG. 1A) may be accessed or received. The activity on the user device may occur at a first time. The indication of an activity on the user device may comprise the secondary device activity 202 of FIG. 2.

The indication of the activity on the user device may comprise an indication of a subject matter of the activity (e.g., the subject matter 204 of FIG. 2). The indication of the subject matter may comprise the subject matter of an application executing and/or being interacting with by the user. The subject matter of a web browser application may comprise the topic of a currently viewed webpage. If the webpage describes the statistics for a particular sports team, the subject matter of the webpage may comprise an indication of the sports team. The subject matter of an application may comprise a type of the application, such as indication that the application is a social media application, a word-processing application, a game application, or a web browser application.

The indication of the activity on the user device may comprise an indication of user interaction (e.g., the indication of interaction 206 of FIG. 2) with the user device and/or applications executing thereon. The indication of the activity may comprise an indication of a type of user inputs. Types of user input may include touch inputs, gesture inputs, or motion inputs. The indication of the activity may comprise a frequency of user interactions. The indication of activity may comprise a number of user interactions within a period of time. The period of time may be predetermined.

The indication of the activity on the user device may comprise an attention factor (e.g., the attention factor 208 of FIG. 2). The attention factor may reflect the degree of attention with which the user regards the user device and/or an application executing thereon. The attention factor may be based on the type of application. Some applications are associated with a high degree of attention and others are associated with a low degree of attention. The attention factor may be based on an internal mode or state of an application. An embedded video in a social media application that is playing may indicate a high degree of attention while the same video in a paused or stopped state may indicate a low degree of attention.

At step 306, at least a second portion of the content asset may be modified to comprise a supplemental content asset (e.g., the supplemental content asset 212 of FIG. 2) associated with the activity on the user device. The supplemental content asset may comprise an advertisement. The modification of the second portion of the content asset may be based on receiving the indication of the activity on the user device in step 304. The content asset so modified may comprise the modified content asset 216 of FIG. 2.

The supplemental content asset used to modify the second portion of the content asset may be based on an indication of the activity on the user device (e.g., the secondary device activity 202 of FIG. 2). The supplemental content asset may comprise a content element, a timing element, and a priority factor element (e.g., the content 213, the timing 214, and the priority factor 215, respectively, of FIG. 2). The content element may comprise the aforementioned advertisement or other type of content, such as an informational message or announcement.

The timing element may comprise an indication with respect to a time and/or a period of time within the content asset that the supplemental content asset may be inserted to modify the content asset. The supplemental content asset may be inserted in the content asset such that the supplemental content asset is designated to be displayed on the primary device at a later specified time.

The priority factor element may represent a relative priority according to which the supplemental content asset is to modify the content asset. A supplemental content asset with a high priority factor may be used instead of another supplemental content asset with a low priority factor.

The content asset may be modified according to one or more of the aforementioned content element, the timing element, and/or the priority factor. The substance of the supplemental content asset may be derived from the content element. The content asset may be modified with the supplemental content asset such that the time at which the modified portion of the content asset is displayed on the primary device conforms with the timing element. The timing element may specify that the supplemental content asset is to be displayed at or within a time period. The time period may be predetermined. The supplemental content asset may be inserted into a particular time point in the content asset so that when the modified content asset is displayed, the supplemental content asset is displayed at or within the time period.

At step 308, the modified second portion of the content asset may be displayed or caused to be displayed (e.g., output or caused to be output) via the primary display device. The modified second portion of the content asset may be displayed or caused to be displayed within a period of time of the first time referenced in step 304. The period of time during which the modified second portion of the content asset may be displayed or caused to be displayed may be predetermined. The period of time may be specified in the timing element. The modified second portion of the content asset may be displayed or caused to be displayed within 10 seconds of the time at which the activity on the secondary device occurred. The display of the supplemental content asset may remain relevant to the activity occurring or that occurred on the secondary device.

Any of the above steps may be performed by any combination of the primary device 102, the secondary device 104, the gateway 106, and/or the computing device 114. Additionally or alternatively, the above steps may be performed by one or more other devices, such as a computing device in a cloud environment.

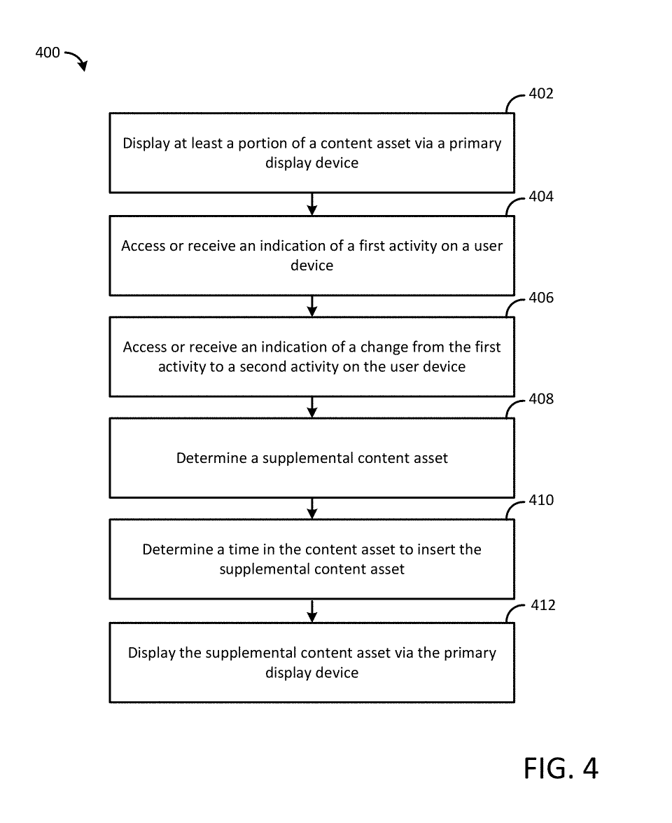

FIG. 4 shows a method 400 to display a supplemental content asset according to activity occurring on a user device. At step 402, at least a portion of a content asset (e.g., the content asset 210 of FIG. 2) is displayed or caused to be displayed (e.g., output or caused to be output) via a primary display device (e.g., the primary device 102 of FIG. 1A). The primary display device may comprise a device configured to display video content. The primary display device may comprise a television display. The primary display device may access or receive the content asset from an upstream component. The content asset may be transmitted to the primary display device as a digital video stream over a co-axial cable network and/or a digital network, such as the Internet. The content asset may comprise a movie, a television program, or a sports event.

At step 404, an indication of a first activity on a user device (e.g., the secondary device 104 of FIG. 1A) may be accessed or received. The indication of the first activity may reflect the subject matter relating to the first activity, user interactions relating to the first activity, and/or an attention factor. The indication of the first activity may reflect activity with respect to an application executing on the secondary device or activity on the secondary device in general.

The subject matter of the first activity may comprise a topic relating to the activity, such as the topic of a web page being viewed. The subject matter may indicate a type or a genre of an application relating to the activity. The subject matter may indicate that an application is a word processing application, a game application, an email application, and/or a social media application. The indication of user interactions may comprise information representing the interactions performed by the user with respect to the user device and/or an application executing thereon. The indication of user interactions may comprise indications of touch inputs or swipe gestures to a touch-sensitive display of the user device. The indication of user interactions may comprise a frequency of inputs over a period of time. The period of time may be predetermined. The attention factor may represent a degree of attention from the user to the user device and/or applications executing thereon. A particular type or genre of application may be associated with a high degree of attention to the user device when this application is executing and/or being interacted with.

At step 406, an indication of a change from the first activity to a second activity on the user device may be accessed or received. The change in activity may be with respect to the subject matter of the activities, the user interaction relating to the activities, and/or an attention factor relating to the activities.

The indication of the change may reflect a change in the types or genres of the applications of the first and second activities. A user may switch from a word processing application to a social media application and such switch may be reflected in the indication of the change of activity. The content and/or display timing of a supplement content asset may be based on the word processing application indicating a relatively high degree of attention to the secondary device and/or the social media application indicating a relatively low degree of attention to the secondary device.

The indication of the first activity may comprise an indication of a frequency of interactions (e.g., user inputs) with the secondary device and/or applications executing thereon. An indication of the first activity may comprise an indication of frequent interactions. The indication of the second activity may comprise an indication of a frequency of interactions (e.g., user inputs) with the secondary device and/or applications executing thereon. An indication of the second activity may comprise an indication of infrequent user interactions with the secondary device and/or applications executing thereon. This change in user interactions may be used to determine the content and/or display timing of a supplemental content asset.

The indication of the first activity may comprise an indication of a first internal state of an application executing on the secondary device and the indication of the second activity may comprise a second internal state of an application executing on the secondary device. The state of the application may reflect a playback mode (e.g., play, pause, etc.) of a video streaming application or a state of a game application (e.g., a paused game state, playing a level or game round, waiting for a level of game round to begin, etc.). The play mode of the video streaming application or the game mode in which a level is being played may indicate a high degree of attention to the application. A paused mode of the video streaming application or the game application may indicate a low degree of attention to the application. The indications of attention to the application and/or secondary device may be used to determine the content and/or display timing of a supplemental content asset.

At step 408, a supplemental content asset (e.g., the supplemental content asset 212 of FIG. 2) may be determined. The determining of the supplemental content asset may be based at least on one or more of the first activity and the second activity on the secondary device. The supplemental content asset may be based on the subject matter, the user interaction, and/or the attention factor relating to the first and/or second activity. A user may switch from a game application to a web browsing application. The web browsing application may display a webpage about a content asset. The supplemental content asset may be based on the content asset. The supplemental content asset may comprise a notification or advertisement of the next showing of the content asset or may comprise an advertisement for a video game or movie related to the content asset. The supplemental content asset may be selected or determined based on the first and/or second activity on the secondary device.

At step 410, a time in the content asset may be determined to insert the supplemental content asset. The determining of the time may be based at least on the indication of the change from the first activity to the second activity. The determined time may be a time relative to the content asset. The determined time may be ten minutes from the beginning of the content asset. The determined time may be based on a time at which the supplemental content asset is to be displayed or output on the primary display device. The beginning of the content asset may be scheduled to display on the primary display device at 7:00 PM. If it is determined that the supplemental content asset is to be displayed at 7:30 PM, the time in the content asset to insert the supplemental content asset may be at the thirty minute mark in the content asset. Thus, the supplemental content asset would display on the primary display device at 7:30 PM.

The determining of the time in the content asset to insert the supplemental content may be based at least on the change from the first activity to the second activity. The change may reflect a change in the subject matter of the activities, a change in the user interaction of the activities, and/or a change in user attention to the activities.

A change from a low attention activity to a high attention activity may indicate that the time in the content asset to insert the supplemental content asset may correspond with a significant period of time from a current time (e.g., greater than a period of time, which may be predetermined). The delay may be caused before the supplemental content asset is displayed on the primary display device. While the user is primarily directing his or her attention to the user device, the supplemental content asset may not be displayed.

A change from a high attention activity to a low attention activity may indicate that the time in the content asset to insert the supplemental content asset may correspond with a relatively small or even real-time (or near real-time) period of time from a current time (e.g., less than a period of time, which may be predetermined). The change from the high attention activity to the low attention activity may indicate that attention is freed from interacting with the secondary device. Based on the change from the high activity to the low activity, the supplemental content asset may be displayed at that time or soon thereafter.

The insertion of the supplemental content asset into the content asset may be in real-time or near real-time. The supplemental content asset may be inserted into the content asset at a time point in the content asset that will be imminently displayed on the primary display device. The supplemental content asset may be inserted at a time in the content asset that is within a period of time from when the content asset is displayed on the primary display device. The period of time from when the content asset is displayed on the primary display device may be predetermined. The supplemental content asset may be inserted within a sequence of segments (or other denomination of portions) of the content asset that is within a number of segments after the segment that will next be displayed. The number of segments after the segment that will next be displayed may be predetermined.

The insertion of the supplemental content asset into the content asset may be predictive. The supplemental content asset may be inserted into the content asset a period of time or number of segments (or other denomination of portions) before the time or segment, respectively, at which the content asset is displayed on the primary display device. The period of time and/or number of segments may be predetermined. This may effectuate a delay before the supplemental content asset is displayed. This delay may be desirable when the activity on the secondary device reflects that the user is currently paying attention to the secondary device instead of the primary display device and it would be more beneficial for the supplemental content asset to be displayed at a later time.

At step 412, the supplemental content asset may be displayed or caused to be displayed (e.g., output or caused to be output) via the primary display device. The display of the supplemental content asset via the primary display device may interrupt the display of the content asset at the selected time in the content asset. A first portion of the content asset may have been displayed on the primary display device. The first portion of the content asset may be prior in the content asset to the time in the content asset at which the supplemental content asset is inserted. Thus, a second portion of the content asset may be subsequent in the content asset to the time in the content asset at which the supplemental content asset is inserted. As one resultant effect, a first portion of the content asset may be initially displayed, the supplemental content asset may be displayed after the first portion of the content asset, and a second portion of the content asset may be displayed after the supplemental content asset.

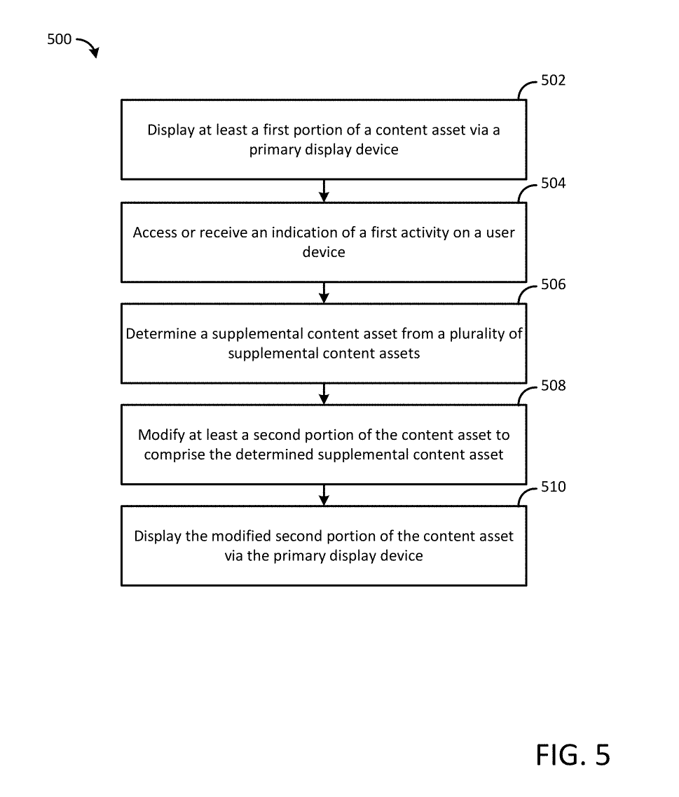

FIG. 5 shows a method 500 to display a supplemental content asset based on activity on a secondary device. At step 502, at least a first portion of a content asset (e.g., the content asset 210 of FIG. 2) may be displayed or caused to be displayed (e.g., output or caused to be output) via a primary display device (e.g., the primary device 102 of FIG. 1A). The primary display device may comprise a device configured to receive and/or display video content. The primary display device may comprise a television display. The primary display device may access or receive video content from an upstream component. The primary display device may access or receive a digital video stream via a co-axial cable network and/or a digital network, such as the Internet. The primary display device may comprise devices to facilitate display of a content asset, such as a digital media player, a set-top cable box, and/or a game console. The content asset may comprise a television program, a movie, a sports event, and/or a music video.

At step 504, an indication of an activity on a secondary device (e.g., the secondary device 104 of FIG. 1A) may be accessed or received. The activity on the secondary device may occur at a first time. The indication of an activity on the secondary device may comprise the secondary device activity 202 of FIG. 2.

The indication of the activity on the secondary device may comprise an indication of a subject matter of the activity (e.g., the subject matter 204 of FIG. 2) relating to an activity on the secondary device and/or an application executing thereon. The indication of the subject matter of the activity may indicate a topic and/or application genre relating to an application executing on the secondary device. The indication of the activity on the secondary device may comprise an indication of user interaction (e.g., the indication of interaction 206 of FIG. 2) with respect to the secondary device and/or application executing thereon. The indication of interaction may reflect a type and/or frequency of inputs to the secondary device and/or applications. The indication of the activity on the secondary device may comprise an attention factor (e.g., the attention factor 208 of FIG. 2) reflecting the degree of attention provided to the secondary device and/or application executing thereon.

At step 506, a supplemental content asset (e.g., the supplemental content asset 212 of FIG. 2) may be determined from a plurality of content assets. The determination of the supplemental content asset may be based, at least in part, on the indication of the activity on the secondary device.

The supplemental content asset(s) may each comprise a content element, a timing element, and a priority factor element (e.g., the content 213, the timing 214, and the priority factor 215, respectively, of FIG. 2). The content element may comprise an advertisement or other type of content, such as an informational message or announcement. The timing element may comprise an indication with respect to a time and/or a period of time within the content asset that the supplemental content asset may be inserted to modify the content asset. The timing element may comprise an indication of a time at which the supplemental content asset may be displayed on the primary display device. The priority factor element may represent a relative priority according to which the supplemental content asset may be selected to modify the content asset.

The plurality of supplemental content assets may be provided by a supplemental content asset repository (e.g., the supplemental content repository 116 of FIG. 1A). The plurality of supplemental content assets may comprise candidate supplemental content assets for potential display in conjunction with the content asset.

The determination of the supplemental content asset from the plurality of supplemental content assets may be based on the indication of activity on the user device, including the subject matter of the activity, the user interactions relating to the activity, and/or the attention factor relating to the activity.

The determination of the supplemental content asset may comprise comparing the subject matter of the activity with the content element of each of the plurality of supplemental content assets. The subject matter may reflect a particular content asset (e.g., a user is browsing a web page for the content asset). A supplemental content asset may be selected from the plurality of supplemental content assets with content that corresponds with (or most closely corresponds with) the content asset.

The determination of the supplemental content asset may be based on the indication of user interaction with the secondary device. A period of frequent inputs may result in a determination of a supplemental content asset that is associated with a low priority factor. The period of frequent user inputs may result in a determination of a supplemental content asset with an associated timing element indicating that the supplemental content asset will be displayed at a later time. This determination may result in a postponement of a display of a supplemental content asset until the user is more likely to pay attention to the primary display device. A period of infrequent inputs may result in a determination of a supplemental content asset that is associated with a high priority factor. The period of infrequent user inputs may cause a determination of a supplemental content asset that is contemporaneous with and/or within a period of the time of the activity. The period of the time of the activity may be predetermined.

The determination of the supplemental content asset from the plurality of supplemental content assets may be based on the attention factor associated with the activity. If the attention factor indicates attention to the secondary device and/or application thereon, a supplemental content asset may be determined that has a low priority factor and/or a timing element indicating that the supplemental content asset will be displayed at a later time. Based on the attention factor indicating attention to the secondary device and/or application thereon, a supplemental content asset may be determined that less matches the subject matter of the activity. Another supplemental content asset that better matches the subject matter of the activity may be determined for display on the primary display device at a later time. This may result in the more relevant supplemental content asset being displayed while the user is more likely to pay attention to the primary display device.

The determination of the supplemental content asset may be based on the time at which the activity occurs (e.g., the aforementioned first time). Each supplemental content asset of the plurality of supplemental content assets may each be associated with a time, either with respect to a time point in the content asset and/or a time at which the supplemental content asset may be displayed on the primary display device. A supplemental content asset may be determined, from the plurality of supplemental content assets, with an associated time that matches or most closely matches the time at which the activity occurs.

At step 508, at least a second portion of the content asset may be modified to comprise the selected supplemental content asset. The content asset so modified may comprise the modified content asset 216 of FIG. 2. The modification of the content asset with the selected supplemental content asset may comprise inserting the supplemental content asset at a time point within the content asset. The segments of the supplemental content asset may be inserted into the segments of the content asset at the time point in the content asset. The time point may correspond with a time at which the supplemental content asset is to be displayed via the primary display device. The time point at which to insert the supplemental content asset may be based on the timing element of the supplemental content asset.

At step 510, the modified second portion of the content asset may be displayed (e.g., output or caused to be output) via the primary display device. The modified second portion of the content asset may be displayed within a period of time of the first time referenced in relation to step 504. The period of time of the first time referenced in relation to step 504 may be predetermined. The modified second portion of the content asset may be displayed via the primary display device relatively soon after (e.g., five of ten seconds) the activity on the user device occurs. The display of the supplemental content asset may be based on the activity on the user device.

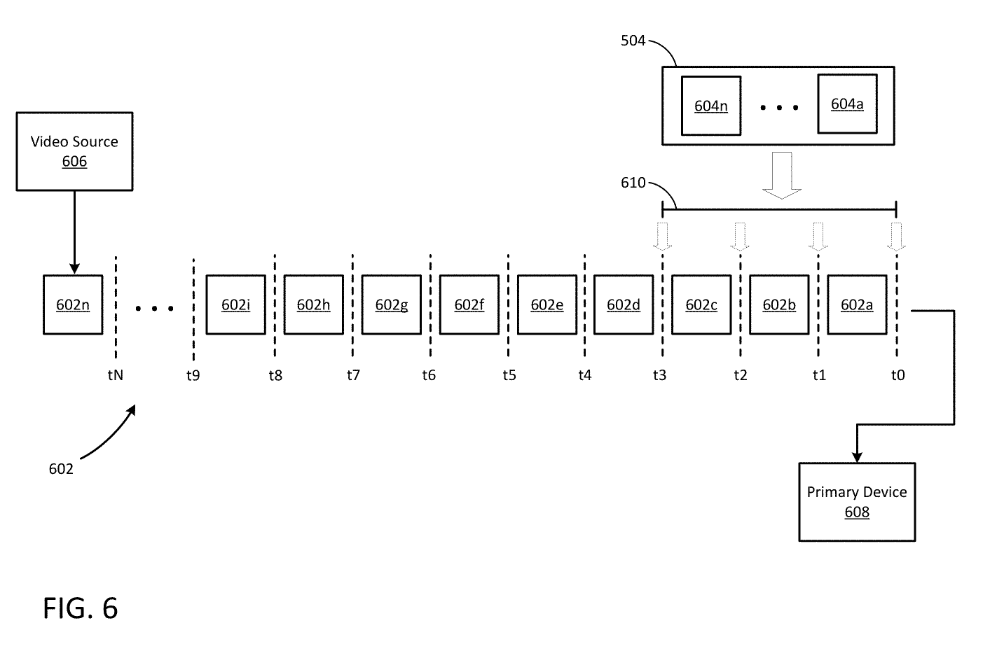

FIG. 6 shows an operation of an insertion of a supplemental content asset into a content asset. A content asset 602 received from a content source 606 may comprise segments 602a-602n (or other unit representing portions of the content asset 602). The segments 602a-602n may be in a sequential order, from right to left, according to their eventual display on a primary device 608. The segments 602a-602n of the content asset 602 may be divided by time points t0-tN in the content asset 602. In the represented content asset 602, the segment 602a prior to the time point t0 will be the next frame displayed or caused to be displayed on the primary device 608. The segment 602b prior to the time point t1 will be displayed after the segment 602a and so forth.

A supplemental content asset 604 may comprise segments 604a-604n (or other unit representing portions of the supplemental content asset 604). The supplemental content asset 604 may be inserted into the content asset 602 such that it may be soon displayed on the primary device 608. The supplemental content asset 604 may be inserted within a period of time with respect to the time point at which the associated segment will be displayed. The period of time may be predetermined. The period of time may be measured by segments. The period of time is represented by a bracket 610. The period of time may span from time point t0 to time point t3. Additionally or alternatively, the period of time may be measured over segment 602a through segment 602c. The supplemental content asset 604 may be inserted at any one of time points t0 through t3. To insert the supplemental content asset 604 in real-time, the supplemental content asset 604 may be inserted at time point t0.

The period of time in which to insert the supplemental content asset 604 may be defined as any time in the content asset 602 that is less than a particular identified time point in the content asset 602. The time points of the period of time may be sequentially prior to the identified time point. The period of time may comprise any time points (inclusively or not) prior to the time point t3 in the sequence of segments of the content asset 602. The period of time may comprise time points t0, t1, and t2 (and time point t3 if considered inclusively).

The operation shown in FIG. 6 may be appropriate when the activity on a secondary device indicates that the user is paying little attention to the secondary device and, presumably, may pay greater attention to the primary device 608. The user may switch from a high attention activity to a low attention activity. Based on the switch from the high attention activity to the low attention activity, the supplemental content asset 604 may be displayed. The supplemental content asset 604 may be displayed at the time of the switch from the high attention activity to the low attention activity.

The period of time need not be contiguous with the time point (e.g., the time point t0) at which the segment of the content asset 602 will be displayed or caused to be displayed on the primary device 608. The period of time may comprise the period of time (not shown) between time points t4 and t6.

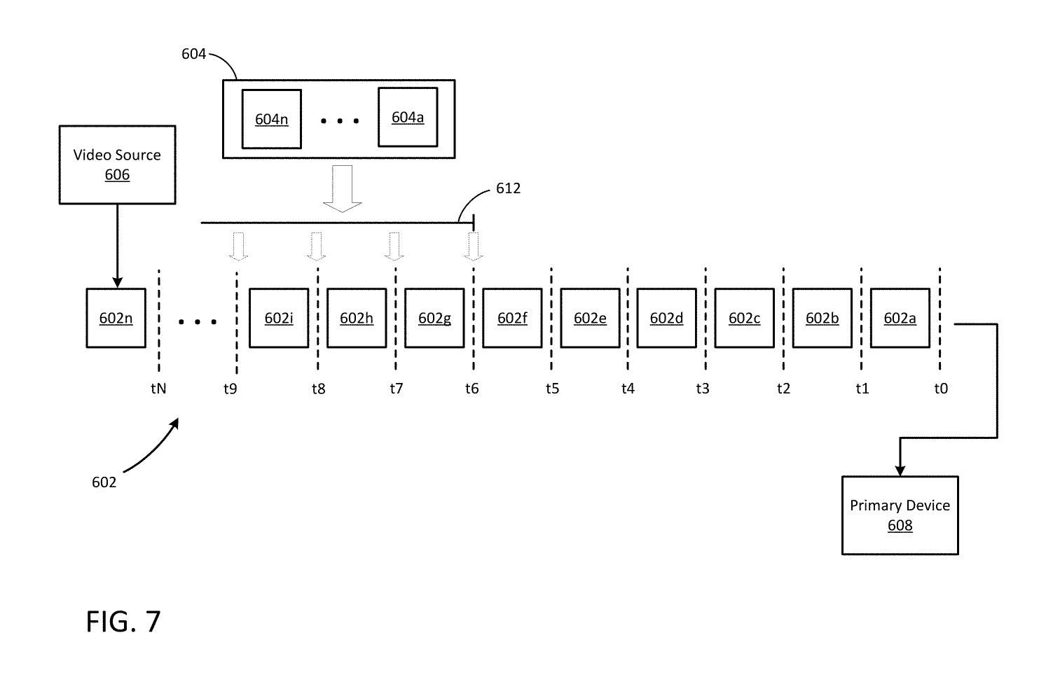

FIG. 7 shows an operation of an insertion of a supplemental content asset into a content asset. Some elements of FIG. 7 are similar in some aspects to those of FIG. 6. Accordingly, like elements are indicated by like reference characters.

The period of time in which to insert the supplemental content asset 604 into the content asset 602 is defined by an open-ended bracket 612. The period of time in which to insert the supplemental content asset 604 into the content asset 602 may be predetermined. The period of time may comprise those time points that are sequentially prior to a particular identified time point in the content asset 602. The identified time point in the content asset 602 is time point t6. The period of time comprises time points t6 (if inclusive), t7, t8, t9, and so forth. The supplemental content asset 604 may be inserted between segment 602g and segment 602h or between segment 602h and segment 602i.

The operations described in FIG. 7 may be appropriate when a delay in displaying the supplement content asset 604 is desirable. The current activity on a secondary device may reflect a high degree of attention to the secondary device. It may be beneficial to delay displaying the supplemental content asset on the primary device 608 until a later point in time since the user may be currently paying more attention to the secondary device than the primary device 608.

Any of the above methods, steps, and/or other techniques described herein may be performed by any combination of the primary device 102, the secondary device 104, the gateway 106, and/or the computing device 114. Additionally or alternatively, the above steps may be performed by one or more other devices, such as a one or more computing devices in a cloud environment.

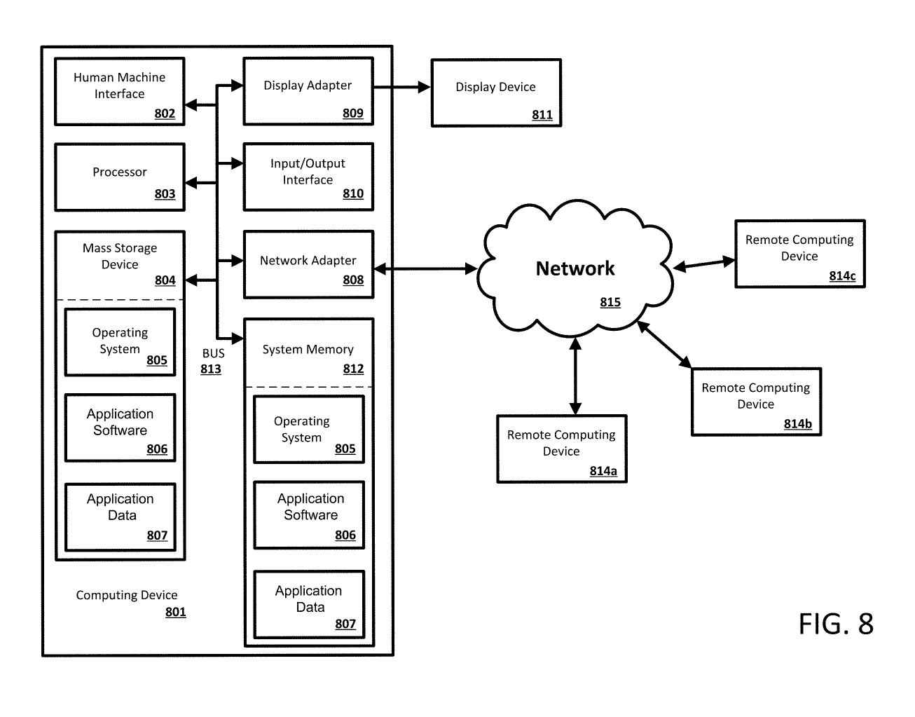

The methods, systems, and apparatuses may be implemented on a computing device such as a computing device 801 (e.g., computer) as shown in FIG. 8. The primary device 102, the secondary device 104, the gateway 106, the computing device 114, and/or the supplemental content repository 116 of FIG. 1A may be a computing device as shown in FIG. 8. The methods, systems, and apparatuses disclosed may utilize one or more computing device to perform one or more functions in one or more locations. FIG. 8 is a block diagram showing an operating environment for performing the disclosed methods, systems, and apparatuses. This operating environment is not intended to suggest any limitation as to the scope of use or functionality of operating environment architecture. Neither should the operating environment be interpreted as having any dependency or requirement relating to any one or combination of components shown in the operating environment.

The methods, systems, and apparatuses may be operational with numerous other general purpose or special purpose computing system environments or configurations. Computing systems, environments, and/or configurations that may be suitable for use with the systems and methods comprise, but are not limited to, personal computers, server computers, laptop devices, and multiprocessor systems. Set top boxes, programmable consumer electronics, network PCs, minicomputers, mainframe computers, distributed computing environments that comprise any of the above systems or devices, and the like may be used to implement the methods, systems, and apparatuses.

The processing of the methods, systems, and apparatuses may be performed by software components. The disclosed methods, systems, and apparatuses may be described in the general context of computer-executable instructions, such as program modules, being executed by one or more computers or other devices. Generally, program modules comprise computer code, routines, programs, objects, components, data structures, etc. that perform particular tasks or implement particular abstract data types. The methods, systems, and apparatuses may also be practiced in grid-based and distributed computing environments where tasks are performed by remote processing devices that are linked through a communications network. In a distributed computing environment, program modules may be located in both local and remote computer storage media including memory storage devices.

The methods, systems, and apparatuses may be implemented via a general-purpose computing device in the form of a computing device 801. The components of the computing device 801 may comprise, but are not limited to, one or more processors 803, a system memory 812, and a system bus 813 that couples various system components including the processor 803 to the system memory 812. In the case of multiple processors 803, the system may utilize parallel computing.

The system bus 813 represents one or more of several possible types of bus structures, including a memory bus or memory controller, a peripheral bus, an accelerated graphics port, and a processor or local bus using any of a variety of bus architectures. Such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 813, and all buses specified in this description may also be implemented over a wired or wireless network connection and each of the subsystems, including the processor 803, a mass storage device 804, an operating system 805, a service software 806, a service data 807, a network adapter 808, system memory 812, an Input/Output Interface 810, a display adapter 809, a display device 811, and a human machine interface 802, may be contained within one or more remote computing devices 814a,b,c at physically separate locations, connected through buses of this form, in effect implementing a fully distributed system.

The computing device 801 comprises a variety of computer readable media. Readable media may be any available media that is accessible by the computing device 801 and comprises both volatile and non-volatile media, removable and non-removable media. The system memory 812 comprises computer readable media in the form of volatile memory, such as random access memory (RAM), and/or non-volatile memory, such as read only memory (ROM). The system memory 812 typically contains data such as service data 807 and/or program modules such as operating system 805 and service software 806 that are immediately accessible to and/or are presently operated on by the processor 803.

The computing device 801 may comprise other removable/non-removable, volatile/non-volatile computer storage media. FIG. 8 shows a mass storage device 804 which may provide non-volatile storage of computer code, computer readable instructions, data structures, program modules, and other data for the computing device 801. A mass storage device 804 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 804, including an operating system 805 and service software 806. Each of the operating system 805 and service software 806 (or some combination thereof) may comprise elements of the programming and the service software 806. Service data 807 may be stored on the mass storage device 804. Service data 807 may be stored in any of one or more databases known in the art. Examples of such databases comprise, DB2®, Microsoft® Access, Microsoft® SQL Server, Oracle®, my SQL, PostgreSQL, and the like. The databases may be centralized or distributed across multiple systems.

The user may enter commands and information into the computing device 801 via an input device (not shown). Input devices may comprise, but are not limited to, a keyboard, pointing device (e.g., a “mouse”), a microphone, a joystick, tactile input devices such as gloves, and other body coverings, and the like. These and other input devices may be connected to the processor 503 via a human machine interface 802 that is coupled to the system bus 813, but may be connected by other interface and bus structures, such as a parallel port, game port, an IEEE 1394 Port (also known as a Firewire port), a serial port, or a universal serial bus (USB).

A display device 811 may also be connected to the system bus 813 via an interface, such as a display adapter 809. The computing device 801 may have more than one display adapter 809 and the computing device 801 may have more than one display device 811. A display device may be a monitor, an LCD (Liquid Crystal Display), or a projector. Output peripheral devices may comprise components such as speakers (not shown) and a printer (not shown) which may be connected to the computing device 801 via Input/Output Interface 810. Any step and/or result of the methods may be output in any form to an output device. Such output may be any form of visual representation, including, but not limited to, textual, graphical, animation, audio, tactile, and the like. The display device 811 and computing device 801 may be part of one device, or separate devices.

The computing device 801 may operate in a networked environment using logical connections to one or more remote computing devices 814a,b,c. A remote computing device may be a personal computer, portable computer, smartphone, a server, a router, a network computer, a peer device or other common network node, and so on. Logical connections between the computing device 801 and a remote computing device 814a,b,c may be made via a network 815, such as a local area network (LAN) and a general wide area network (WAN). Network connections may be through a network adapter 808. A network adapter 808 may be implemented in both wired and wireless environments.

Application programs and other executable program components such as the operating system 805 are shown herein as discrete blocks, although it is recognized that such programs and components reside at various times in different storage components of the computing device 801, and are executed by the data processor(s) of the computer. An implementation of service software 806 may be stored on or transmitted across some form of computer readable media. Any of the disclosed methods, systems, and apparatuses may be performed by computer readable instructions embodied on computer readable media. Computer readable media may be any available media that may be accessed by a computer. Computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

As used in the specification and the appended claims, the singular forms “a,” “an” and “the” include plural referents unless the context clearly dictates otherwise. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed systems, methods, and apparatuses. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps and/or components in disclosed methods, systems, and apparatuses. If there are a variety of additional steps that may be performed it is understood that each of these additional steps may be performed with any specific embodiment or combination of embodiments of the disclosed methods, systems, and apparatuses.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
causing, via a primary display device, output of at least a first portion of a content asset;
determining activity on a user device associated with user attention to the user device;
modifying, based on at least the determining the activity on the user device associated with user attention, at least a second portion of the content asset to comprise a supplemental content asset associated with the activity on the user device; and
causing, via the primary display device, output of the modified second portion of the content asset.

2. The method of claim 1, wherein the supplemental content asset is contextually associated with the activity on the user device.

3. The method of claim 1, further comprising:
determining the supplemental content asset based on at least the activity on the user device associated with user attention.

4. The method of claim 1, wherein the activity on the user device occurs at a first time and the output of the modified second portion of the content asset is caused within a first period of time of the first time.

5. The method of claim 4, wherein the activity on the user device indicates a frequency of user inputs to the user device over a second period of time, the second period of time comprises the first time, and the method further comprises:
determining the supplemental content asset based on at least the frequency of user inputs to the user device over the second period of time.

6. The method of claim 1, wherein the primary display device and the user device are associated with a premises network.

7. The method of claim 1, wherein the activity on the user device is determined by an application executing on the user device.

8. A method comprising:
causing, via a primary display device, output of at least a portion of a content asset;
determining first activity on a user device;
determining a change from the first activity to a second activity on the user device, wherein the second activity is different from the first activity;
determining, based on at least one or more of the first activity and the second activity, a supplemental content asset;
determining, based on at least the change from the first activity to the second activity, a time in the content asset to insert the supplemental content asset; and
causing, via the primary display device, output of the supplemental content asset, wherein the output of the supplemental content asset interrupts the output of the content asset at the determined time in the content asset.

9. The method of claim 8, wherein the first activity is a high attention activity and the second activity is a low attention activity.

10. The method of claim 8, wherein the first activity is associated with a first type of application and the second activity is associated with a second type of application, wherein the second type of application is different from the first type of application.

11. The method of claim 8, wherein the change from the first activity to the second activity comprises a change from a first frequency of user inputs associated with the first activity to a second frequency of user inputs associated with the second activity.

12. The method of claim 8, wherein the change from the first activity to the second activity comprises a change from a first internal state of an application executing on the user device to a second internal state of the application.

13. The method of claim 8, wherein the change from the first activity to the second activity comprises a change from a first subject matter associated with the first activity to a second subject matter associated with the second activity.

14. The method of claim 8, wherein the change of the first activity to the second activity occurs at a second time, and the output of the supplemental content asset interrupting the output of the content asset occurs within a period of time of the second time.

15. A method comprising:
causing, via a primary display device, output of at least a first portion of a content asset;
determining activity on a user device associated with user attention to the user device;
determining, based on at least the activity on the user device associated with user attention, a supplemental content asset from a plurality of supplemental content assets;
modifying at least a second portion of the content asset to comprise the determined supplemental content asset; and
causing, via the primary display device, output of the modified second portion of the content asset.

16. The method of claim 15, wherein the activity on the user device indicates a subject matter of activity and the determining the supplemental content asset comprises comparing the subject matter of activity with a subject matter of each of the plurality of supplemental content assets.

17. The method of claim 15, wherein the determining the supplemental content asset comprises comparing a priority factor associated with each supplemental content asset of the plurality of supplemental content assets with the priority factor associated with each of the other supplemental content assets of the plurality of supplemental content assets.

18. The method of claim 15, wherein the activity on the user device occurs at a first time and the output of the modified second portion of the content asset is caused within a first period of time of the first time.

19. The method of claim 18, wherein the activity on the user device indicates a frequency of user inputs to the user device over a second period of time, the second period of time comprises the first time, and the determining the supplemental content asset is based on at least the frequency of user inputs.

20. The method of claim 15, wherein the activity on the user device indicates a degree of user attention to the user device and the determining the supplemental content asset is based on at least the degree of user attention.
